(19) United States
(12) Patent Application Publication
(10) Pub. No.: US 2023/0066609 A1
(43) Pub. Date: Mar. 2, 2023

(54) TESTING DEVICE FOR AN ACTIVE OPTICAL SENSOR

(71) Applicant: Robert Bosch GmbH, Stuttgart (DE)

(72) Inventor: Johannes Richter, Ludwigsburg (DE)

(21) Appl. No.: 17/793,783

(22) PCT Filed: May 4, 2021
(86) PCT No.: PCT/EP2021/061723

§ 371 Date: Jul. 19, 2022

(30) Foreign Application Priority Data
May 5, 2020 (DE) 10 2020 205 650.1

(51) Int. Cl. G01S 7/497

(52) U.S. Cl. CPC G01S 7/497

(57) ABSTRACT

A testing device for an active optical sensor. The testing device includes an imaging optical system including a first optical element and a second optical element, each having a beam-forming effect. The imaging optical system is situatable at a predefined position with a predefined orientation with respect to a surroundings interface of an active optical sensor to be tested, in such a way that light beams emitted by the active optical sensor into the surroundings of the active optical sensor and portions of the emitted light beams reflected or scattered from the surroundings to the active optical sensor in each case pass through the imaging optical system. The first optical element and the second optical element are configured to guide incoming light beams over an optical path of the testing device so that the light beams are imaged over a distance that is shorter than a predefined measuring distance.

### FIELD

The present invention relates to a testing device for an active optical sensor, and to use of the testing device for checking the active optical sensor.

### BACKGROUND INFORMATION

Highly automated and fully automated means of transportation (i.e., transportation devices) are described in the related art, which, for controlling the means of transportation, carry out a detection of the surroundings based on surroundings sensors. Video cameras, LIDAR sensors, radar sensors, or ultrasonic sensors are suitable as such surroundings sensors. In particular, LIDAR sensors play an increasingly important role for such automatedly traveling means of transportation.

An important performance indicator for LIDAR sensors is a maximum range under predefined conditions. Typical ranges of LIDAR sensors are 100 m to 300 m, which makes it difficult to directly test the range, for example in manufacturing facilities, since a length of a measuring section necessary for this purpose is often not available. Laser power, receiver sensitivity, and an optical adjustment between sender and receiver, among other things, are checked in the course of such range tests.

The transmitting objectives and receiving objectives of such LIDAR sensors are typically focused to infinity. Therefore, meaningful range tests in the close range of these sensors in a direct manner are not possible.

### SUMMARY

The present invention provides a testing device for an active optical sensor. In accordance with an example embodiment of the present invention, the testing device includes an imaging optical system, the imaging optical system including at least a first optical element and a second optical element, each of which has a beam-forming effect and predefined optical properties. It is noted that the first optical element and the second optical element may have identical or different optical properties.

The imaging optical system is situatable at a predefined position with a predefined orientation with respect to a surroundings interface (light entry opening or light exit opening) of an active optical sensor to be tested in such a way that light beams emitted by the active optical sensor into the surroundings of the active optical sensor and portions of the emitted light beams reflected or scattered from the surroundings to the active optical sensor in each case pass through the imaging optical system. The predefined position and the predefined orientation of the imaging optical system may be ensured, for example, by fastening the active optical sensor and the imaging optical system on a jointly utilized fastening system (for example, a carrier plate, a carrier rod system, etc.) and/or to a jointly utilized housing and/or with the aid of further fastening variants. The active optical sensor and/or the imaging optical system may preferably be fastened reversibly, and further preferably with the aid of a quick-assembly mechanism, to the jointly utilized fastening system in order to simplify tests of a plurality of active optical sensors, using the testing device according to the present invention. The active optical sensor to be tested is preferably a far-field sensor, and further preferably is a sensor of a surroundings detection system of a means of transportation, without thus limiting the optical sensor to these characteristics.

In accordance with an example embodiment of the present invention, the first optical element and the second optical element are configured to guide light beams, entering the testing device, over an optical path of the testing device in such a way that the light beams are imaged over a distance that is shorter than a predefined measuring distance, which in particular is a typical inherent measuring distance of active optical sensors to be tested. In this regard, it is noted that in addition to the first optical element and the second optical element, the testing device may include third, fourth, or further optical elements, which likewise may be situated in the optical path of the testing device and which may have an imaging effect and/or a beam-steering effect (deflection mirrors, for example).

Based on the above-described configuration of the testing device for the active optical sensor, it is thus possible to test the active optical sensor using a greatly shortened measuring section (for example, less than 2 m in length), since the light beam received in the active optical sensor, which passes through the imaging optical system twice (forward and back) upon striking a sensor surface of the active optical sensor, has essentially the same properties with regard to the beam forming as for a free field test of the active optical sensor. An additional reduction of a signal strength of the light emitted by the active optical sensor via the testing device, which simulates an attenuation during a free space test and thus allows a test scenario that is particularly close to reality, is described in greater detail below.

Preferred refinements of the present invention are disclosed herein.

In accordance with an example embodiment of the present invention, the first optical element is preferably a converging lens or an off-axis parabolic mirror, while the second optical element is likewise preferably a converging lens or an off-axis parabolic mirror. Both the first optical element and the second optical element may particularly preferably be off-axis parabolic mirrors since, in contrast to converging lenses, they are not dependent on wavelength, and in a broadband range are free of spherical aberrations. In addition, the off-axis parabolic mirrors offer the advantage that they generate only extremely low scattered light. Due to these advantageous properties of the off-axis parabolic mirrors, they are particularly advantageously usable for the optical sensor in conjunction with the testing device proposed here, since they have only a minimal interfering influence on the system to be tested, i.e., the active optical sensor. The off-axis parabolic mirrors may each have, for example, a deflection angle of 45° or a different deflection angle (for example, 15°, 30°, 45°, 60°, etc.). In addition, the first optical element and the second optical element may have different deflection angles.

The testing device according to an example embodiment of the present invention particularly preferably further includes a housing with at least one first opening, the housing being stationarily connected to the first optical element and to the second optical element in an inner space of the housing. In addition, the housing is configured to guide light beams, emitted by the active optical sensor, to the imaging optical system via the first opening, and to guide reflected or scattered portions of the emitted light beams back to the active optical sensor via the first opening. The housing may include, for example, metal and/or plastic and/or glass and/or wood and/or a composite material and/or some other material. The first opening is preferably an unclosed recess in a wall of the housing. Alternatively, the recess in the wall of the housing is closed (for example, airtight, dust-tight, etc.) via a window that is preferably made of a material that allows light beams to pass through essentially uninfluenced in a wavelength range used by the active optical sensor. A first opening that is closed in this way offers the advantage that no contaminants that impair the functioning of the testing device can penetrate into the testing device. To avoid undesirable scattered light at the window surface via a window that is used, a suitable antireflective coating is preferably provided at the window.

The housing is preferably designed, in particular using materials that are impermeable to light, to shield the optical path of the testing device from extraneous light influences from the surroundings of the testing device. A further advantage that is achievable with the aid of the housing is that scattered light that is generated within the testing device may be absorbed, at least in part, by the housing, in that the inner walls of the housing are provided with an absorbent material. Furthermore, it is advantageously provided that the housing includes a second opening. Thus, light beams that enter through the first opening and are further guided by the imaging system through the second opening may be radiated into the surroundings of the testing device. The second opening may be designed analogously to the first opening, and may represent an opening that is closed by a window, or an unclosed opening. The light beams exiting through the second opening may be subsequently reflected or scattered, in the surroundings of the testing device, back to the second opening of the testing device, and guided back to the active optical sensor via the imaging optical system and the first opening. As an alternative to using a second opening, the light beams of the active optical sensor that are further guided by the imaging system may also be reflected or scattered at an inner surface of the housing and subsequently guided back to the active optical sensor via the imaging optical system and the first opening. In other words, a reference target that is to be detected with the aid of the active optical sensor (for example, a surface having predefined reflection properties and/or predefined patterns) may be situated outside the housing of the testing device or inside the housing of the testing device.

In accordance with an example embodiment of the present invention, the testing device is preferably configured to image a measuring distance of the active optical sensor of at least 50 m, in particular at least 100 m, and particularly preferably at least 150 m, over a length of the optical path of the testing device. It is noted that the testing device may also be designed for other, different measuring distances of the active optical sensor.

As already mentioned above, the testing device may bring about a reduction of a signal strength of the light emitted by the active optical sensor. For this purpose, the testing device particularly preferably includes a signal attenuator that is configured to attenuate the light beams, which are emitted or received by the active optical sensor, to such an extent that the attenuation corresponds essentially to a free space attenuation of a measuring section of the active optical sensor when the testing device is not in use. The signal attenuator may be implemented, for example, based on a gray filter and/or a beam splitter and/or an LC display. The signal attenuator may preferably be situated within the testing device at a predefined angle with respect to the optical path of the testing device. The predefined angle may correspond, for example, to an angle of 30°, 45°, 60°, or some other angle. It shall be understood that a predefined angle of 0° may also be used. However, an angle that is different from 0° offers the advantage that there is little or no coupling of reflections, possibly occurring at the signal attenuator, into the useful signal of the active optical sensor. The signal attenuator may also be configured to bring about a variable attenuation. This may be achieved in particular in conjunction with the LC display proposed above, whose light permeability may be changed via electrical control, which is conventional in the related art. Such control may take place, for example, by using an evaluation unit that may be connected to the LC display using information technology. Alternatively or additionally, it is also possible to automatically introduce a movably situated gray filter and/or a movably situated beam splitter into the optical path or automatically remove it/them from the optical path. It is thus possible to also provide a plurality of gray filters and/or beam splitters, each of which may have different attenuation properties, and which may be automatically introduced into the optical path as a function of an attenuation needed at that moment. As a further option for reducing the light intensity of the light emitted by the active optical sensor, as an alternative or in addition to the measures described above, a transmission power output of the active optical sensor may be adapted.

In accordance with an example embodiment of the present invention, the testing device preferably also includes the predefined reference target already mentioned above, it being possible for the reference target to be situated and configured, inside or outside the housing at a predefined distance from the imaging optical system, to reflect or scatter light beams, emitted by the active optical sensor, in the direction of the imaging optical system. Alternatively or additionally, the predefined reference target has a pattern and/or a size that are/is adapted to an imaging ratio of the imaging optical system. Such a pattern may be, for example, a checkerboard pattern or a Siemens star or some other pattern.

Furthermore, in one preferred embodiment of the present invention, the testing device includes a diffuse light source that is configured to couple interfering light components into the light beams that are emitted or received by the active optical sensor. These interfering light components may be coupled in, for example, via a beam splitter situated in the optical path of the testing device. Alternatively or additionally, the interfering light components may be coupled in by illuminating the reference target into the light beams of the active optical sensor. By use of such a diffuse light source, unfavorable test conditions for a particular active optical sensor to be tested may be created in a targeted manner, for example to allow checking of the interference susceptibility of the particular active optical sensor. The diffuse light source may preferably be automatically and/or manually deactivated to allow tests to be carried out under both disturbed and undisturbed boundary conditions.

The active optical sensor may, for example, be a time-of-flight sensor, and in particular a LIDAR sensor, it being possible for the LIDAR sensor to be designed as a flash LIDAR sensor or as a point scanner or as a line scanner or as a column scanner. In addition, the optical sensor may be a sensor with a coaxial or biaxial design with regard to a transmission path and a reception path. Furthermore, optical sensors that differ from these may also be tested with the aid of the testing device according to the present invention.

Moreover, the present invention relates to use of the testing device as described above for checking a maximum range of the active optical sensor and/or for determining an angular precision and/or an angular correctness and/or a resolution of the active optical sensor, and optionally for other types of tests.

### BRIEF DESCRIPTION OF THE DRAWINGS

Exemplary embodiments of the present invention are described in greater detail below with reference to the figures.

FIG. 1 shows a schematic side view of a first exemplary embodiment of a testing device according to an example embodiment of the present invention for an active optical sensor.

FIG. 2 shows a schematic top view of a second exemplary embodiment of a testing device according to an example embodiment of the present invention for an active optical sensor.

### DETAILED DESCRIPTION OF EXAMPLE EMBODIMENTS

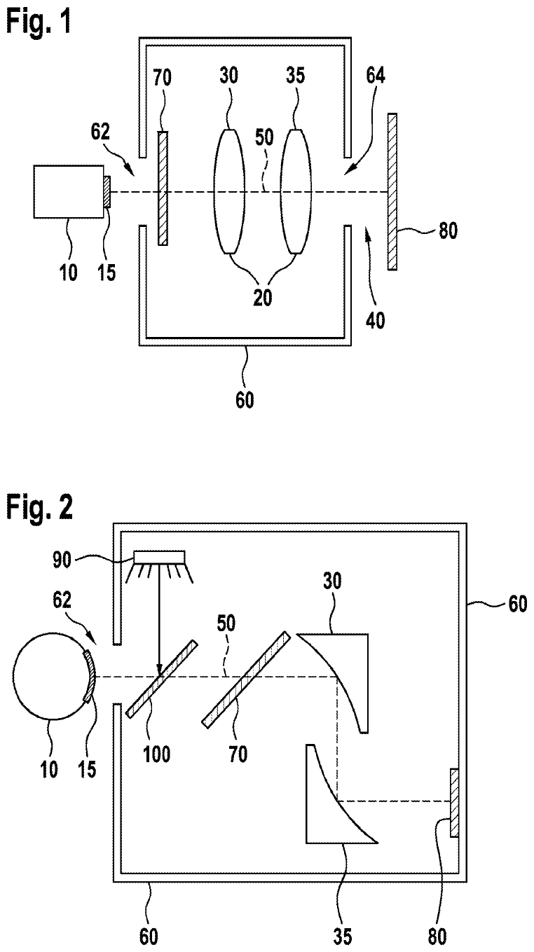

FIG. 1 shows a schematic side view of a first exemplary embodiment of a testing device according to the present invention for an active optical sensor 10, which in the present case is a LIDAR sensor for a means of transportation (not shown) (i.e., a transportation device). The testing device includes a first converging lens 30 having first predefined optical properties, and a second converging lens 35 having second predefined optical properties, which are situated within an optical path 50 of the testing device and which form an imaging optical system 20. In addition, the testing device includes a gray filter 70 which likewise is situated within optical path 50. First converging lens 30, second converging lens 35, and gray filter 70 are fastened to one another at predefined distances and with predefined orientations relative to one another with the aid of respective mountings (not illustrated) at a side face of a housing 60 of the testing device. Housing 60, which in this exemplary embodiment is made of aluminum, includes a first opening 62 and a second opening 64. Active optical sensor 10 is situated at a predefined distance in the area of first opening 62 of housing 60 in such a way that a light beam exiting from a light exit opening 15 of active optical sensor 10 enters the testing device through first opening 62, along optical path 50. The light beam emitted by active optical sensor 10, after passing through imaging optical system 20 of the testing device, is radiated into surroundings 40 of the testing device via second opening 64. At that location the light beam is reflected or scattered at a predefined reference target 80 and is guided back to active optical sensor 10 via second opening 64.

FIG. 2 shows a schematic top view of a second exemplary embodiment of a testing device according to the present invention for an active optical sensor 10, which in the present case is a LIDAR sensor in the form of a point scanner. In this exemplary embodiment, the testing device includes a first off-axis parabolic mirror 30 having first predefined optical properties, and a second off-axis parabolic mirror 35 having predefined second optical properties, which are stationarily situated, at a predefined distance and with a predefined orientation relative to one another, inside a plastic housing 60 of the testing device according to the present invention, and which form an imaging optical system 20. The testing device also includes an LC display 70 which, the same as first off-axis parabolic mirror 30 and second off-axis parabolic mirror 35, is situated in an optical path 50 of the testing device and which is likewise stationarily situated at housing 60. LC display 70 is configured to be controlled by an evaluation unit (not shown) in such a way that the LC display may variably reduce a light intensity of a laser light beam of active optical sensor 10. In addition, the testing device includes a beam splitter 100 that is configured to couple light of a diffuse interfering light source 90 into optical path 50 of the testing device. The laser light emitted by active optical sensor 10 via a surroundings interface 15 is guided through a first opening 62 of housing 60 via beam splitter 100, LC display 70, first off-axis parabolic mirror 30, and second off-axis parabolic mirror 35 to a predefined reference target 80 situated at an inner wall of housing 60. Portions of the laser light of active optical sensor 10 that are reflected or scattered by reference target 80 are guided over the reverse path back to active optical sensor 10, and received and processed by same.

1-11. (canceled)

12. A testing device for an active optical sensor, comprising:
an imaging optical system that includes at least a first optical element and a second optical element, the first optical element and the second optical element each having a beam-forming effect;
wherein the imaging optical system is configured to be situated with respect to a surroundings interface of an active optical sensor to be tested, in such a way that light beams emitted by the active optical sensor into the surroundings of the active optical sensor and portions of the emitted light beams reflected or scattered from the surroundings to the active optical sensor in each case pass through the imaging optical system, and the first optical element and the second optical element being configured to guide incoming light beams over an optical path of the testing device in such a way that the light beams are imaged over a distance that is shorter than a predefined measuring distance, which an inherent measuring distance of an active optical sensor to be tested.

13. The testing device as recited in claim 12, wherein the first optical element is a converging lens or an off-axis parabolic mirror, and the second optical element is a converging lens or an off-axis parabolic mirror.

14. The testing device as recited in claim 12, further comprising:
a housing that includes at least one first opening, the housing being configured to be stationarily connected at least to the first optical element and to the second optical element in an inner space of the housing, and to guide light beams, emitted by the active optical sensor, to the imaging optical system via the first opening, and to guide reflected or scattered portions of the emitted light beams back to the active optical sensor via the first opening.

15. The testing device as recited in claim 14, wherein the housing is configured to:
shield the optical path of the testing device from extraneous light influences from the surroundings of the testing device, and/or
absorb, at least in part, scattered light that is generated within the testing device, and/or
for light beams that enter through the first opening and are further guided by the imaging system, to radiate the light beams into the surroundings of the testing device via a second opening of the housing, or to reflect or scatter the light beams at an inner surface of the housing.

16. The testing device as recited in claim 12, wherein the testing device is configured to image a measuring distance of the active optical sensor of at least 50 m over a length of the optical path of the testing device.

17. The testing device as recited in claim 12, wherein the testing device is configured to image a measuring distance of the active optical sensor of at least 100 m over a length of the optical path of the testing device.

18. The testing device as recited in claim 12, wherein the testing device is configured to image a measuring distance of the active optical sensor of at least 150 m, over a length of the optical path of the testing device.

19. The testing device as recited in claim 12, further comprising:
a signal attenuator configured to attenuate the light beams, which are emitted or received by the active optical sensor, to such an extent that the attenuation corresponds to a free space attenuation of a measuring section of the active optical sensor when the testing device is not in use.

20. The testing device as recited in claim 19, wherein the signal attenuator is:
implemented based on a gray filter, and/or a beam splitter, and/or an LC display; and/or
situated within the optical path at a predefined angle with respect to the optical path of the testing device; and/or
configured to bring about a variable attenuation.

21. The testing device as recited in claim 12, further comprising:
a predefined reference target, the reference target:
being situated and configured, inside or outside the housing, at a predefined distance from the imaging optical system, to reflect or scatter light beams, emitted by the active optical sensor, in a direction of the imaging optical system, and/or
having a pattern and/or a size that is adapted to an imaging ratio of the imaging optical system.

22. The testing device as recited in claim 12, further comprising:
a diffuse light source configured to couple interfering light components into the light beams that are emitted or received by the active optical sensor.

23. The testing device as recited in claim 12, wherein the testing device is configured to test a LIDAR sensor, the LIDAR sensor being configured as a flash LIDAR sensor, or a point scanner, or a line scanner, or a column scanner.

24. The testing device as recited in claim 12, wherein the testing device is configured to check a maximum range of the active optical sensor, and/or an angular precision of the active optical sensor, and/or an angular correctness of the active optical sensor, and/or a resolution of the active optical sensor.
